(19) United States
(12) Patent Application Publication
(10) Pub. No.: US 2013/0158950 A1
(43) Pub. Date: Jun. 20, 2013

(54) APPLICATION PERFORMANCE ANALYSIS THAT IS ADAPTIVE TO BUSINESS ACTIVITY PATTERNS

(71) Applicants: Alain J. COHEN, McLean, VA (US); Yiping DING, Dover, MA (US); Stefan ZNAM, Rockville, MD (US)

(72) Inventors: Alain J. COHEN, McLean, VA (US); Yiping DING, Dover, MA (US); Stefan ZNAM, Rockville, MD (US)

(73) Assignee: OPNET Technologies, Inc., Bethesda, MD (US)

(21) Appl. No.: 13/570,572

(22) Filed: Aug. 9, 2012

Related U.S. Application Data
(60) Provisional application No. 61/521,828, filed on Aug. 10, 2011.

(51) Int. Cl. G06F 17/00

(52) U.S. Cl. CPC G06F 17/00
USPC 702/176

(57) ABSTRACT

The present invention relates to a system and method for assessing application performance. hi some embodiments, the analysis considers external factors, such as business hours, time zone, etc., to identify or recognize distinctive intervals of application performance. These distinctive intervals correspond to different periods of activity by an enterprise or business and may occur in a cyclical manner or other type of pattern. The distinctive intervals defined by external factors are employed in the analysis to improve aggregating of statistics, setting of thresholds for performance monitoring and alarms, correlating business and performance, and the modeling of application performance. The metrics measured can include, among other things, measures of CPU and memory utilization, disk transfer rates, network performance, queue depths and application module throughput. Key performance indicators, such as transaction rates and round-trip response times may also be monitored.

### CROSS-REFERENCE TO RELATED APPLICATIONS

This application claims the benefit of U.S. Provisional Patent Application 61/521,828, entitled “Business-Hour-Oriented Performance Analysis,” filed Aug. 10, 2011, which is expressly incorporated by reference herein in its entirety.

### FIELD

The embodiments relate to application performance monitoring and management. More particularly, the embodiments relate to systems and methods for computing thresholds based on activity patterns of an enterprise.

### BACKGROUND

Application performance management relates to technologies and systems for monitoring and managing the performance of applications. For example, application performance management is commonly used to monitor and manage transactions performed by an application running on a server to a client.

With the advent of new technologies, the complexity of an enterprise information technology (IT) environment has been increasing. Frequent hardware and software upgrades and changes in service demands add additional uncertainty to business application performance. In order to function efficiently, enterprises try to optimize transaction performance, and this requires the monitoring, careful analysis and management of transactions and other system performance metrics.

Unfortunately, due to the complexity of modern enterprise systems, it may be necessary to monitor thousands of performance metrics, ranging from relatively high-level metrics, such as transaction response time, throughput and availability, to low-level metrics, such as the amount of physical memory in use on each computer on a network, the amount of disk space available, or the number of threads executing on each processor on each computer. Metrics relating to the operation of database systems and application servers, operating systems, physical hardware, network performance, etc. all must be monitored across networks that may include many computers, each executing numerous processes, so that problems can be detected and corrected when or as they arise.

Due to the number of metrics involved, it is useful to be able to call attention to only those metrics that indicate that there may be abnormalities in system operation, so that an operator of the system does not become overwhelmed with the amount of information that is presented. Therefore, most application monitoring systems determine which metrics are outside of the bounds of their normal behavior and provide an alarm when this occurs.

Many monitoring systems allow an enterprise to manually or individually set the thresholds beyond which an alarm should be triggered. In complex systems that monitor thousands of metrics, however, individually setting such thresholds may be labor intensive and error prone. Additionally, fixed thresholds are inappropriate for many metrics. For example, a fixed threshold for metrics that are time varying are inapplicable. If the threshold is set too high, significant events may fail to trigger an alarm. If the threshold is set too low, false alarms are generated.

In addition, many performance metrics vary significantly according to time-of-day, day-of-week, or other types of activity cycles. Thus, for example, a metric may have one range of expected values during one part of the day, and a substantially different set of expected values during another part of the day. The known application monitoring systems, even with dynamic threshold systems, fail to adequately address this issue.

### BRIEF DESCRIPTION OF THE DRAWINGS

The invention is explained in further detail, and by way of example, with reference to the accompanying drawings wherein:

FIG. 1A shows an exemplary system in accordance with an embodiment of the present invention;

FIG. 1B shows an exemplary monitoring server in accordance with an embodiment of the present invention;

FIGS. 2A and 2B show exemplary intervals of time for metrics that are discontinuous;

FIG. 3 illustrates how different intervals of time will exhibit different behavior;

FIG. 4 illustrates use of a convention moving threshold that assumes metric data is continuous in nature;

FIG. 5 shows an exemplary lag in threshold adjustment when assuming that metric data is continuous in nature;

FIG. 6 shows exemplary thresholds that result from interval-oriented analysis of the metric data;

FIGS. 7A and 7B shows exemplary metric data having normal and exponential distribution, respectively;

FIG. 8 shows how setting threshold without using interval-oriented analysis can lead to false or missed alarms;

FIG. 9 shows exemplary thresholds that result from interval-oriented analysis that more accurately capture abnormal metric data;

FIG. 10 illustrates convention correlation that do not employ interval-oriented analysis and results in an erroneous correlation;

FIG. 11 shows an exemplary use of interval-oriented analysis for correlating metrics across different intervals;

FIG. 12 shows the effect of defining distinct intervals on calculating correlation coefficients; and

FIG. 13 shows how different intervals of time may result in a metric that exhibits different distribution characteristics.

Throughout the drawings, the same reference numerals indicate similar or corresponding features or functions. The drawings are included for illustrative purposes and are not intended to limit the scope of the invention.

### DETAILED DESCRIPTION

Overview

The embodiments of the present invention provide improved systems and methods for application performance monitoring. Conventional application performance monitoring continuously measures application performance and treats performance data as a continuous stream. This form of monitoring assumes that system activity is related to its recent history.

However, activities of an enterprise or business will have theft own timetables that influence system and application usage patterns and performance. These external factors, such as business hours, time zone, geography, etc., will affect the activity that needs to be supported by a monitored system. Activities of an enterprise or business will often have very distinct intervals of different intensity levels over time and according to different cycles or patterns. For example, the hours of 9 AM to 5 PM are typically considered primary operating hours of a business and are usually very active. As another example, a factory or manufacturing facility may operate 24 hours per day, but employ different shifts having various activity levels. Moreover, many enterprises or businesses may have operations around the world that work at different times within a given day due to differences in time zone, etc. Thus, for many enterprises or businesses, there are frequently distinctive intervals of activity and those intervals may not be continuous and may not be related to each other.

Unfortunately, there isn't a performance analysis method, model, or capacity-planning tool that works for all data patterns. Oftentimes, simple and closed formulas work only for a specific type of data distribution, and for general distributions, there exists only approximation formulas and heuristic procedures. These conventional techniques often fail to keep up with a dynamic environment and data patterns that change from time to time according to business hours or cycles.

interval-Oriented Performance Monitoring and Analysis

In the embodiments, system and application tools collect a large plurality of data metrics from a system. In the present invention, however, application performance metric data is not treated as a continuous stream. Instead, in the embodiments, external factors, such as business hours, time zone, etc., are used to identify or recognize distinctive intervals of application performance. These distinctive intervals correspond to different periods of activity by an enterprise or business and may occur in a cyclical manner or other type of pattern.

The distinctive intervals defined by external factors are employed in the analysis to improve aggregating of statistics, setting of thresholds for performance monitoring and alarms, correlating business and performance, and the modeling of application performance.

The metrics measured can include, among other things, utilization, throughput, wait time, and queue depths of CPUs, disks, and network components. Key performance indicators, such as transaction rates, round-trip response times, memory utilization, and application module throughput may also be monitored.

Certain embodiments of the inventions will now be described. These embodiments are presented by way of example only, and are not intended to limit the scope of the inventions. Indeed, the novel methods and systems described herein may be embodied in a variety of other forms. Furthermore, various omissions, substitutions and changes in the form of the methods and systems described herein may be made without departing from the spirit of the inventions. For example, for purposes of simplicity and clarity, detailed descriptions of well-known components, such as circuits, are omitted so as not to obscure the description of the present invention with unnecessary detail. To illustrate some of the embodiments, reference will now be made to the figures.

Exemplary System

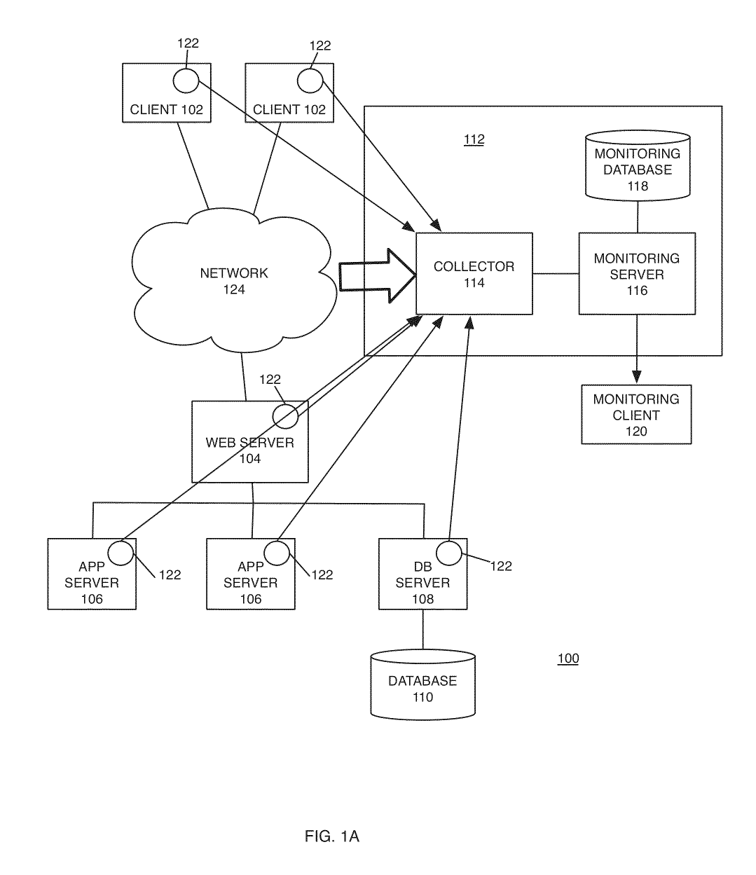

FIG. 1A illustrates an exemplary system to support an application and an application performance management system consistent with some embodiments of the present invention. As shown, the system 100 may comprise a set of clients 102, a web server 104, application servers 106, a database server 108, a database 110, and application performance management system 112. The application performance management system 112 may comprise a collector 114, a monitoring server 116, and a monitoring database 118. The application performance management system 112 may also be accessed via a monitoring client 120. These components will now be further described.

Clients 102 refer to any device requesting and accessing services of applications provided by system 100. Clients 102 may be implemented using known hardware and software. For example, clients 102 may be implemented on a personal computer, a laptop computer, a tablet computer, a smart phone, and the like. Such devices are well-known to those skilled in the art and may be employed in the embodiments.

The clients 102 may access various applications based on client software running or installed on the clients 102. The clients 102 may execute a thick client, a thin client, or hybrid client. For example, the clients 102 may access applications via a thin client, such as a browser application like Internet Explore, Firefox, etc. Programming for these thin clients may include, for example, JavaScript/MX JSP, ASP, PHP, Flash, Siverlight, and others. Such browsers and programming code are known to those skilled in the art.

Alternatively, the clients 102 may execute a thick client, such as a stand-alone application, installed on the clients 102. Programming for thick clients may be based on the .NET framework, Java, Visual Studio, etc.

Web server 104 provides content for the applications of system 100 over a network, such as network 124. Web server 104 may be implemented using known hardware and software to deliver application content. For example, web server 104 may deliver content via HTML pages and employ various IP protocols, such as HTTP.

Application servers 106 provide a hardware and software environment on which the applications of system 1000 may execute. In some embodiments, applications servers 106 may be implemented based as Java Application Servers, Windows Server implement a .NET framework, LINUX, UNIX, WebSphere, etc. running on known hardware platforms. Application servers 106 may be implemented on the same hardware platform as the web server 104, or as shown in FIG. 1A, they may be implemented on theft own hardware.

In the embodiments, applications servers 106 may provide various applications, such as mail, word processors, spreadsheets, point-of-sale, multimedia, etc. Application servers 106 may perform various transactions related to requests by the clients 102. In addition, application servers 106 may interface with the database server 108 and database 110 on behalf of clients 102, implement business logic for the applications, and other functions known to those skilled in the art.

Database server 108 provides database services access to database 110 for transactions and queries requested by clients 102. Database server 108 may be implemented using known hardware and software. For example, database server 108 may be implemented based on Oracle, DB2, Ingres, SQL Server, MySQL, etc. software running on a server.

Database 110 represents the storage infrastructure for data and information requested by clients 102. Database 110 may be implemented using known hardware and software. For example, database 110 may be implemented as relational database based on known database management systems, such as SQL, MySQL, etc. Database 110 may also comprise other types of databases, such as, object oriented databases, XML databases, and so forth.

Application performance management system 112 represents the hardware and software used for monitoring and managing the applications provided by system 100. As shown, application performance management system 112 may comprise a collector 114, a monitoring server 116, a monitoring database 118, a monitoring client 120, and agents 122. These components will now be further described.

Collector 114 collects application performance information from the components of system 100. For example, collector 114 may receive information from clients 102, web server 104, application servers 106, database server 108, and network 124. The application performance information may comprise a variety of information, such as trace files, system logs, etc. Collector 114 may be implemented using known hardware and software. For example, collector 114 may be implemented as software running on a general-purpose server. Alternatively, collector 114 may be implemented as an appliance or virtual machine running on a server.

Monitoring server 116 hosts the application performance management system. Monitoring server 116 may be implemented using known hardware and software. Monitoring server 116 may be implemented as software running on a general-purpose server. Alternatively, monitoring server 116 may be implemented as an appliance or virtual machine running on a server.

Monitoring database 118 provides a storage infrastructure, for storing the application performance information processed by the monitoring server 116. As will be described further below, the monitoring database 118 may comprise various types of information, such as the raw data collected from agents 122, refined or aggregated data created by the monitoring server 116, alarm threshold data, and various definitions of intervals that may exist in the activities of system 100. Monitoring database 118 may be implemented using known hardware and software.

Monitoring client 120 serves as an interface for accessing monitoring server 116. For example, monitoring client 120 may be implemented as a personal computer running an application or web browser accessing the monitoring server 120.

Agents 122 serve as instrumentation for the application performance management system. As shown, the agents 122 may be distributed and running on the various components of system 100. Agents 122 may be implemented as software running on the components or may be a hardware device coupled to the component. For example, agents 122 may implement monitoring instrumentation for Java and .NET framework applications. in one embodiment, the agents 122 implement, among other things, tracing of method calls for various transactions. In particular, in some embodiments, agents 122 may interface known tracing configurations provided by Java and the .NET framework to enable tracing continuously and to modulate the level of detail of the tracing.

Network 124 serves as a communications infrastructure for the system 100. Network 124 may comprise various known network elements, such as routers, firewalls, hubs, switches, etc. In the embodiments, network 124 may support various communications protocols, such as TCP/IP. Network 124 may refer to any scale of network, such as a local area network, a metropolitan area network, a wide area network, the Internet, etc.

Exemplary Monitoring Server

Referring now to FIG. 1B, a more detailed view of the monitoring server 116 is shown. The monitoring server 116 may comprise a data aggregator 200, a threshold engine 202, a correlation engine 204, a modeling engine 206, and an alarm engine 208. In addition, for purposes of illustration, the monitoring server 116 may read, write, or create/derive/refine data from monitoring database 118. In some embodiments, these components are provided within the monitoring server 116. These components may be implemented as a software component of the monitoring server 116. Alternatively, these components may be implemented on a computer or other form of hardware configured with executable program code. Furthermore, the monitoring server 116 may be implemented across multiple machines that are local or remote to each other. The components of monitoring server 116 are described further below.

As also shown in FIG. 1B, the monitoring server 116 may utilize a raw data store 210, interval definitions 212, refined data 214, and threshold data 216 from the monitoring database 118.

For example, the monitoring server 116 is configured to receive raw monitoring data provided by agents 122. in some embodiments, the raw data from agents 122 is temporarily stored in raw data store 210 in monitoring database 118.

Use of External Factors to Define Intervals

As shown in FIG. 1B, the monitoring server 116 may employ information from interval definitions 212. The intervals stored in intervals definitions 212 may be based on any length of time, such as times of day, days of the weeks, weeks of a month, months of year, holidays, etc.

In some embodiments, the monitoring server 116 is provided explicit definition of the intervals, for example, from a user or system administrator via client 120, or other source. Alternatively, the monitoring server 116 may employ heuristics to select certain intervals based on knowledge of external factors, such as business hours, time zone, location, recurring patterns, etc.

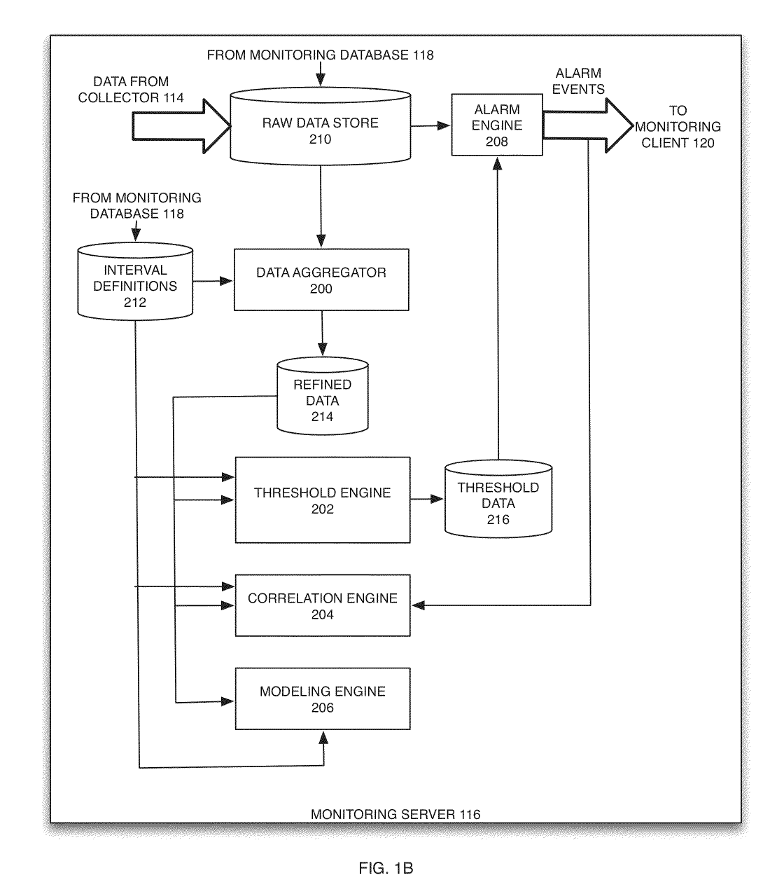

For purposes of illustration, intervals related to business hours are provided with regard to the embodiments. For example, the hours for “weekdays 9 to 5” are separated by 15 hours or by a weekend. FIG. 2A illustrates an exemplary timeline of intervals for business hours. As shown, the business hours for “weekdays 9 to 5” are separated by 15 hours or by a weekend. Thus, these intervals for business hours are distinct and are not continuous.

FIG. 2B illustrates that the intervals for business hours shown in FIG. 2A may be cyclical. For example, as shown in FIG. 2B, multiple weeks of business hours may be defined for day after day, week after week, etc., and are shown as a rectangular prism.

Data Aggregation According to Interval-Oriented Patterns

As noted, the monitoring server 116 may comprise a data aggregator 200. The data aggregator 200 aggregates the data, and if appropriate, refines the raw data from raw data store 210. In the embodiments, the raw data is usually collected by the agents 122 at a high frequency, e.g., every second, every minute, etc. The data aggregator 200 then aggregates this raw data for a larger interval, e.g., every 15 minutes.

During operation, the data aggregator 200 aggregates the data based on an interval-oriented information. For example, in some embodiments, the data aggregator 200 is configured to recognize a current interval based on referencing information from the interval definitions store 212. The data aggregator 200 may then use the interval definitions to bound or limit the data it aggregates so that only data from within a selected interval are used. The data aggregator 200 then stores the aggregated data in a refined data store 214, which is accessible by the other components of the monitoring server 116.

Conventionally, raw data is continuously and uniformly aggregated, e.g., data is aggregated every 15 minutes and statistics, such as the average and the standard deviation, are computed and stored at the end of each 15 minutes. This fixed interval aggregation for a performance metric proceeds continuously as an automated process. This form of continuous aggregation is simple and easy to implement. Unfortunately, this type of aggregation does not take distinct intervals, such as business hours, into account.

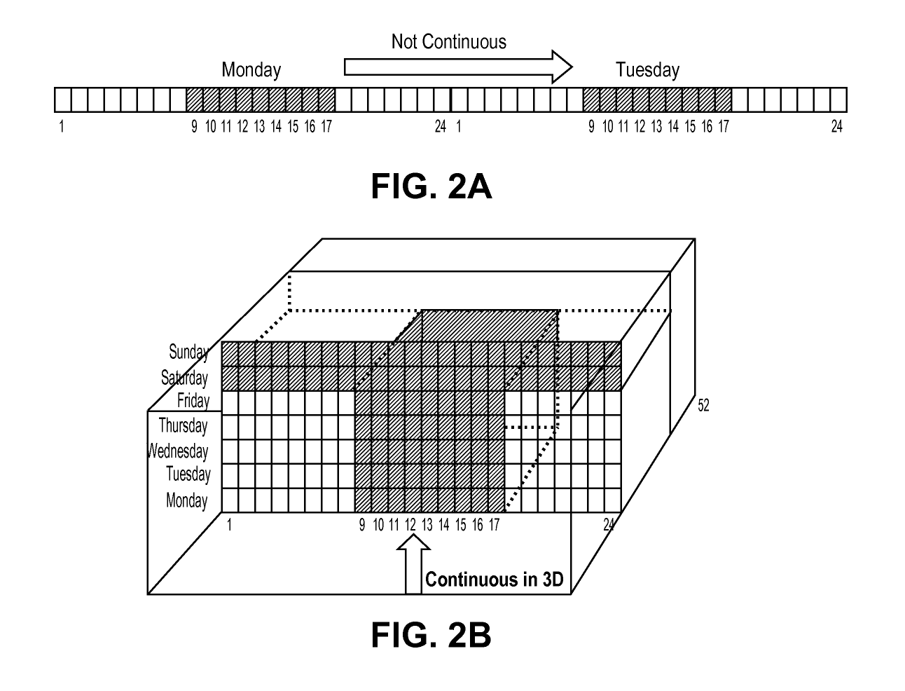

When aggregating data across two very different intervals or business hours, the resulting statistics will not be a good representation or summarization of either of those two business hours. For example, as shown in FIG. 3, there are two very different business hours, “Biz hour I” and “Biz hour II”.

Conventional systems do not distinguish between distinct intervals such as these and will simply calculate the average and the standard deviation with the data from both Biz hour I and II collectively, As shown in FIG. 3, this results in a much higher standard deviation because the data varies more when it changes from one business hour pattern to the other.

In contrast, with the information from interval definitions 212, the data aggregator 200 is configured to recognize the two business hours as being part of different intervals and computes the average and the standard deviation separately for each business hour. This results in a standard deviation for each interval that is more relevant, i.e., an average of 4.5 and standard deviation of 1.5 for Biz hour and an average of 0.5 and standard deviation of 0.5 for Biz hour II.

Table 1 is also provided below and shows some common statistics for different business hours displayed in FIG. 3.

| | Data from Biz | Data from Biz | Data from All |
|---|---|---|---|
| | Hour I | Hour II | Hours |
| Average | 4.55 | 0.53 | 1.87 |
| Standard Deviation | 1.55 | 0.51 | 2.14 |
| Coefficient of | 0.34 | 0.96 | 1.14 |
| Variation | | | |

As indicated in Table 1, the average for “All Hours” is between the averages for Biz Hour I and Biz Hour II. However, the standard deviation for All Hours is much higher than both of Biz Hour I and Biz Hour II. Also of note, the coefficient of variation for the data from All Hours is also higher than that of Biz hours I or II individually. The coefficient of variation can have a significant impact on the calculation of application wait times and delays. Therefore, by using interval-oriented aggregation, the data aggregator 200 can more accurately aggregate data that is relevant to a particular interval.

Data “Borrowing” for Aggregation

As noted above, the data aggregator 200 recognizes different intervals of data and separately aggregates data from these intervals. At the beginning of the data collection process for an interval, the data aggregator 200 may have to wait until it can accumulate sufficient data. For example, an interval for the business hour of “9 am-noon every Monday” generates only three data points every 7 days, assuming statistics are computed hourly by the data aggregator 200. At this pace, it will take the data aggregator 200 about 14 weeks to gather 42 data points. For purposes of explanation, this condition is referred to as a “cold start”

In some embodiments, in order to overcome a cold start, the data aggregator 200 may use a data borrowing technique. In particular, as noted above, the agents 122 can collect data with 1-second granularity, i.e., 900 points for 15 minutes. Accordingly, the data aggregator 200 may borrow this high granularity data and extrapolate it for the interval until sufficient data has been accumulated.

In other words, the data aggregator 200 uses data of different scales to extrapolate the data for the entire interval. For example, the data aggregator 200 can use 1-second granularity data and extrapolates this data for longer time intervals. As another example, the data aggregator 200 can use aggregated 15 minutes of data as one hour. Thus, for the scenario above, the data aggregator 200 may borrow data for the “9 am to noon” business hour by dividing it into three 1-hour sub-time-classes, or into twelve 15-minute sub-time classes and extrapolating the data from these periods for the entire interval of 9 am to noon.

The data aggregator 200 may determine whether data borrowing can be employed based on various factors. For example, the data aggregator 200 may analyze the data to determine if it exhibits self-similarity. Data is considered self-similar if varies substantially the same on any scale. In other words, the data shows the same or similar statistical properties at different scales or granularity. In some embodiments, the data aggregator 200 is configured to use data borrowing for network and/or Internet traffic, since this type of data has been found to be self-similar. When sufficient data is accumulated, the data aggregator 200 may then phase out the borrowed data.

Threshold Engine for Setting Thresholds for Performance Monitoring According to Intervals

In some embodiments, the monitoring server 116 may also comprise a threshold engine 202 to more accurately analyze the application performance data and determine thresholds that indicate abnormal conditions. As described below, the threshold engine 202 employs interval-oriented analysis, such as for business hours.

Typical performance tools monitor system or application performance continuously. To capture and alert abnormal behaviors, thresholds are set for performance metrics either manually or automatically. Since there is a plethora of performance metrics that are measured in system 100, setting thresholds manually for all metrics may not be feasible. Accordingly, threshold engine 202 is provided in monitoring server 116 to automate the process of setting and maintaining thresholds for various metrics.

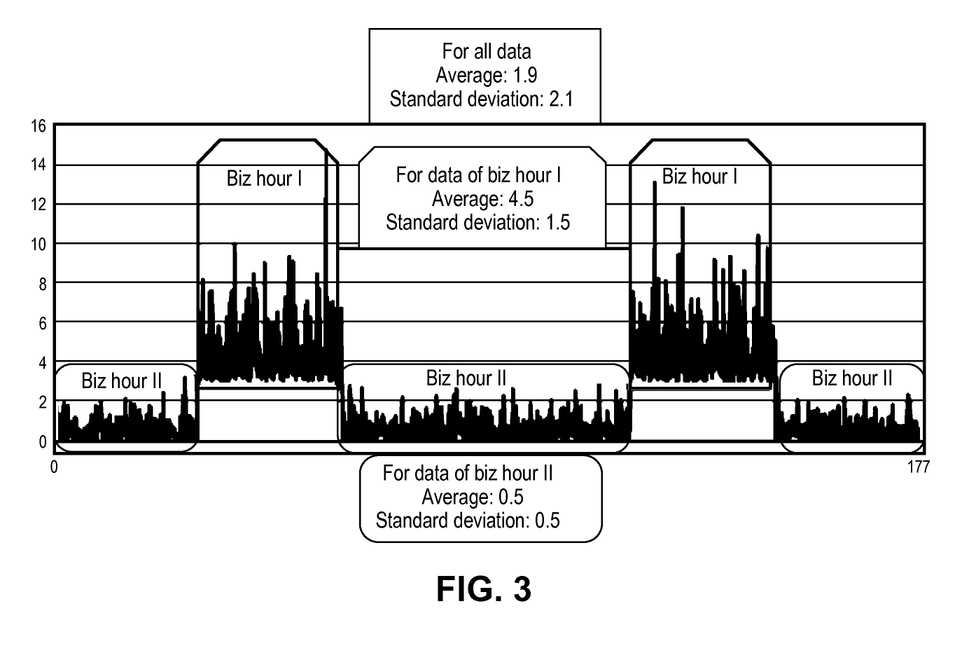

In the prior art, a common approach is to compute the thresholds automatically based on the data of a previous time interval, such as a few minutes, a few hours, etc. For example, a “mean+3* standard deviation” of the past 15 minutes was often used as the threshold for upcoming data. In turn, the data becomes part of the “past 15 minutes” to compute the threshold for the next data point, and so forth. In other words, there is a continuous moving window of 15-minute data that is used to compute the threshold for the new data. FIG. 4 shows an example of conventional moving thresholds derived from the data of the immediate past of 15 minutes (MW90) and 60 minutes (MW360).

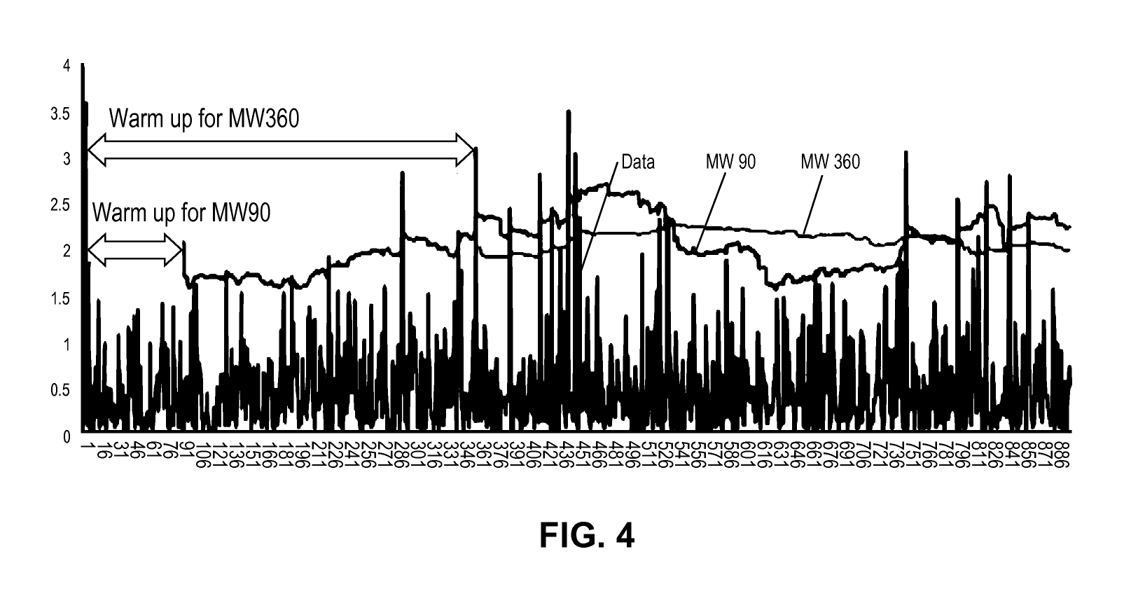

Although a continuous moving window of data to set thresholds is simple and easy to implement, it has drawbacks. For example, the previous moving window interval may not be a good representation of the following interval, especially when significant business activities change from one interval to another. Although the moving window may eventually catch up and adapt to new data patterns in the new interval, the threshold calculated will not be appropriate for the new data pattern. The duration of the delay depends on the size of the moving window. FIG. 5 shows the lag in threshold to adjust to a new interval of performance data.

In contrast to the prior art, the threshold engine 202 is configured to perform its analysis with interval definitions. For example, intervals for business hour definitions may be recorded in interval definitions 212 and provided to the threshold engine 202. Accordingly, threshold engine 212 computes thresholds using the data from refined data 214 within the business hours indicated in the interval definitions 212. Accordingly, the thresholds will be much more relevant to the activity, especially at the boundaries between business hour patterns.

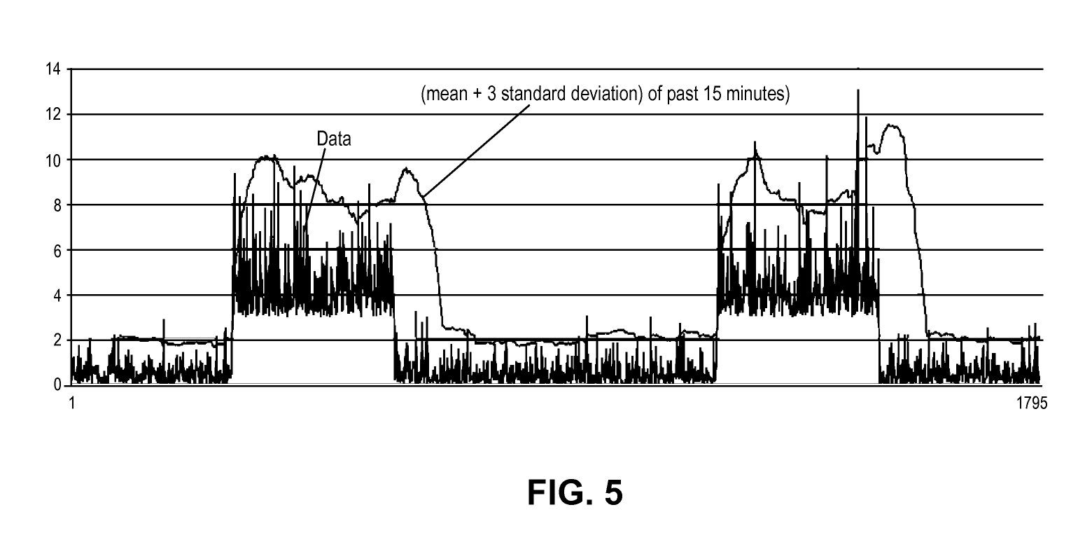

For example, FIG. 6 shows a data pattern similar to that of FIG. 5, but the thresholds are specifically computed for corresponding business hours with the data from the business hours. As shown in FIG. 6, by using interval-oriented analysis, the threshold computed by the threshold engine 212 for a business hour is not affected by the data of another business hour. In addition, the threshold boundaries are clearly defined without a delay in responding to changing business patterns.

In FIG. 6, the arrows indicate that the threshold for each business hour is continuous even through there is another business hour pattern in-between. Similarly, the threshold for the other business hour is continuous as well.

In some embodiments, the threshold engine 202 uses aggregated data prepared by data aggregator 200 and stored in refined data store 214. Alternatively, the threshold engine 202 may analyze raw data 210 collected by collectors 114. The threshold engine 202 may then store its results in threshold data store 216, for example, for use by alarm engine 208.

Use of Improved Thresholds to Set Realistic SLAB

In some embodiments, the threshold engine 202 and threshold data 216 are used to set improved service level agreements (SLA), An SLA that is too restrictive may trigger unnecessary alerts and an SLA that is too liberal may not capture legitimate violations. In addition, users' expectations and tolerance levels are different at different time intervals.

The probability of a performance metric value, X, exceeding a threshold, t (from threshold data 216), can be represented as

P(X≧t)=∫ₜ^{∞}ƒ(x)dx,
where ƒ(x)is the probability density function (PDF) for the performance metric values. For most performance metrics, the specific PDF is unknown. Usually estimates for P(X≧t)are made based on measurements or a statistical upper bound. As described below, using interval-oriented analysis (such as business hour information from interval definitions 212), the threshold engine 202 will not only make the threshold setting more relevant, but also make estimating P(X≧t) more accurate.

The probability of a performance metric value, X, exceeding a threshold, t, P(X>t), for two well-known distributions, the exponential and normal distributions, will now be described below.

For the exponential distribution, we have an explicit expression:

P(X≧t)=∫ₜ^{∞}ƒ(x)dx=e^{-λt},
where 1/λ is the mean of the distribution. Since for the exponential distribution the standard deviation, σ, equals the mean, 1/λ, mean+n*σ=1/λ+n/λ=(n+1)/λ. Therefore,

P[X≧(mean+nσ)]=∫_{means+σ}^{∞}ƒ(x)dx=e^{-λ(n+1)/λ}=e⁻⁽ⁿ⁺¹⁾.

If the p-th percentile is provided (such as for an SLA), then n in the equivalent mean+n*σ can be computed as follows:

n=−[1+1n(13−p/100)].

For example, if p=98, i.e., 98-th percentile, then that is about “mean+3*σ”:

n=−[1+1n(1−p/100)]=−[1+1n(1−98/100)]=2.9≈3.

In general, the percentile from the distribution function, P(X≦t) can be computed. The percentile is simply P(X≦t)*100. For an exponential distribution, it is P(X≦t)*100=(1−e^{-λt})*100 as discussed above.

The relationship between the p-th percentile and mean+n* σdepends on the distribution function. As an estimate, the threshold engine 202 can use bounds. Based on statistic and probability theory, no more than 1/(1+n²) of the distribution's values can be more than n standard deviations away from the mean, that is

$$P ( X \geq mean + n σ ) \leq \frac{1}{1 + {n}^{2}} .$$

Let t=P(X≧mean+nσ), we have

$$t \leq \frac{1}{1 + {n}^{2}} .$$

### That is

$$n \leq \sqrt{\frac{1 - t}{t}} .$$

For example, when t=0.1, i.e., if, for any distribution, 90% of the data that is below a threshold, the upper bound of the threshold is mean+n*σ, where

$$n \leq \sqrt{\frac{1 - 0.1}{0.1}} = \sqrt{\frac{0.9}{0.1}} = 3.$$

In other words, 90% of the data will be below the threshold “mean+3 σ”, regardless of the data distribution function.

Table 2 shows the percentage of metric values that is below “mean+n standard deviation” threshold for exponential distribution, normal distribution, or any distribution when n=1, 2, 3, and 4. For example, if the threshold is set to be “mean+4 standard deviation”, then about 94% of the values of any metric will be below the threshold. if the values are exponentially distributed, then 99.3% of the values will be below the threshold. For a normal distribution, the percentage is even higher (99.997%).

TABLE 2
Percentage of data that is below different
thresholds of mean + n standard deviation.

| | Exponential | Normal | Any |
|---|---|---|---|
| | Distribution | Distribution | Distribution |
| Mean + standard | 86.466 | 84.134 | >50.000 |
| deviation | | | |
| Mean + 2 standard | 95.021 | 97.725 | >80.000 |
| deviation | | | |
| Mean + 3 standard | 98.168 | 99.865 | >90.000 |
| deviation | | | |
| Mean + 4 standard | 99.336 | 99.997 | >94.118 |
| deviation | | | |

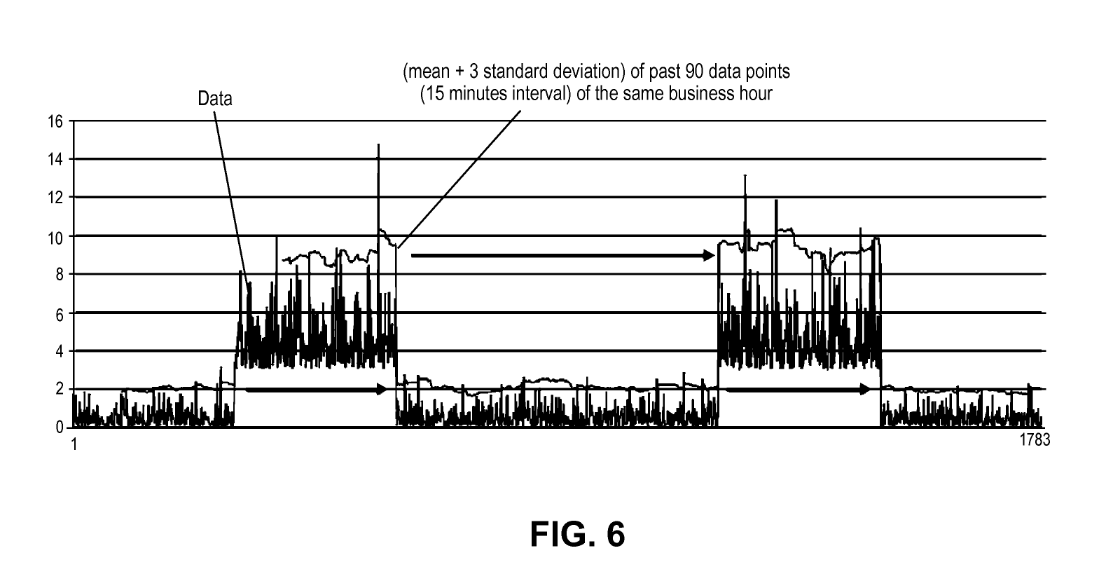

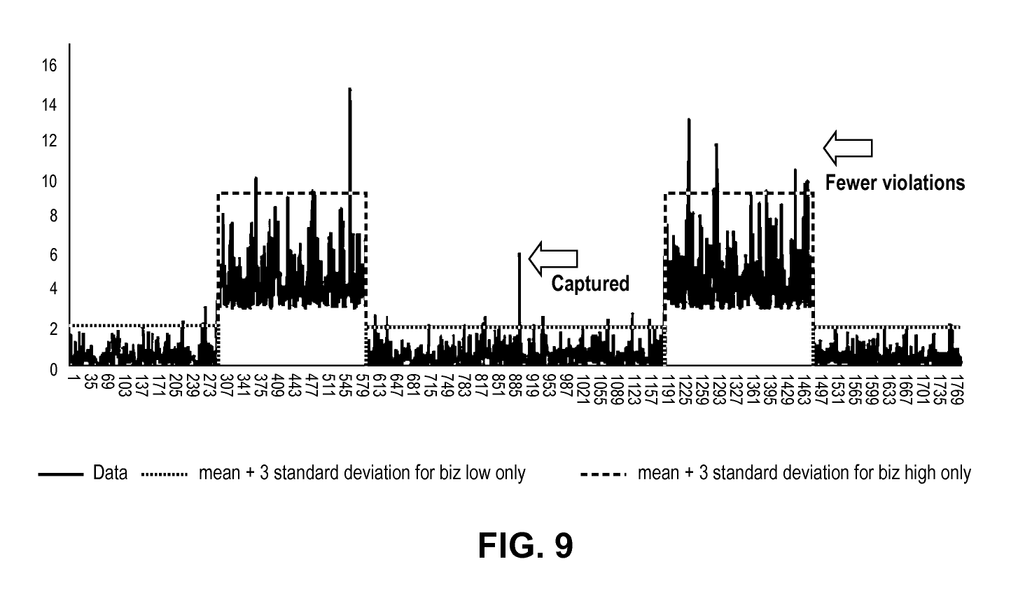

FIGS. 7A and 7B show 1000 data points with normal and exponential distributions, respectively. Both distributions have similar means (about 0.5) and standard deviations (about 0.5). However, with a similar threshold of mean+3σ≈0.5+3*0.5=2, the data with an exponential distribution has many more violations. In fact, according to table 2, about 1.83% of data is above the threshold (see FIG. 10B). For 1000 data points shown in the figure, that is about 18 data points (1000*1.83%). On the other hand, for the normal distribution, only about 0.14% of the data value is above the threshold. For 1000 data points, that is about 1 data point as shown in FIG. 7A. If the distribution for the data is unknown, the upper bound for the number of data points is known above mean+3 standard deviation, e.g., the number will be less than 10%. For example, for 1000 data points, that will be less than 100, regardless of how the data values are distributed.

FIGS. 7A and 7B show that as far as a threshold of mean+nσs concerned, the underlining distribution matters, even when the first two moments of the data are the same. Furthermore, as noted, even with the same distribution when distribution parameters change (for instance, to a different mean) for part of the data (interval) the overall underlining distribution may change as well. Therefore, setting thresholds based on intervals more accurately follow the change in distributions and patterns.

Use of Interval Oriented Thresholds for Improved Alarms

Alarm engine 206 detects when individual metrics are in abnormal condition based on thresholds provided from threshold data 216, and produces threshold alarm events. Alarm engine 206 may use both fixed, user-established thresholds, and thresholds derived from a statistical analysis of the metric itself by threshold engine 202.

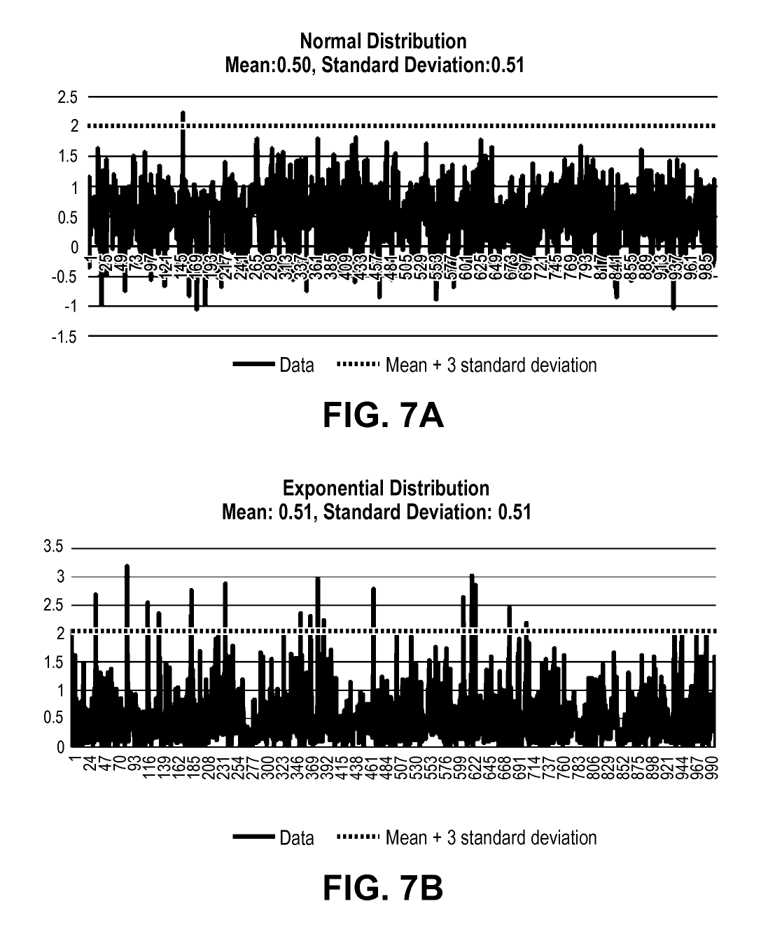

FIG. 8 illustrates that setting thresholds without considering intervals (such as business hours) may lead to more false alarms and, at the same time, missing more abnormal events. As shown, FIG. 8 has two very distinctive business hour patterns: one has much larger average values than the other. The threshold shown was computed based on the average and standard deviation of the data from all business hours, which makes the threshold too low for the business hour with larger average values and too high for the business hour with smaller average values.

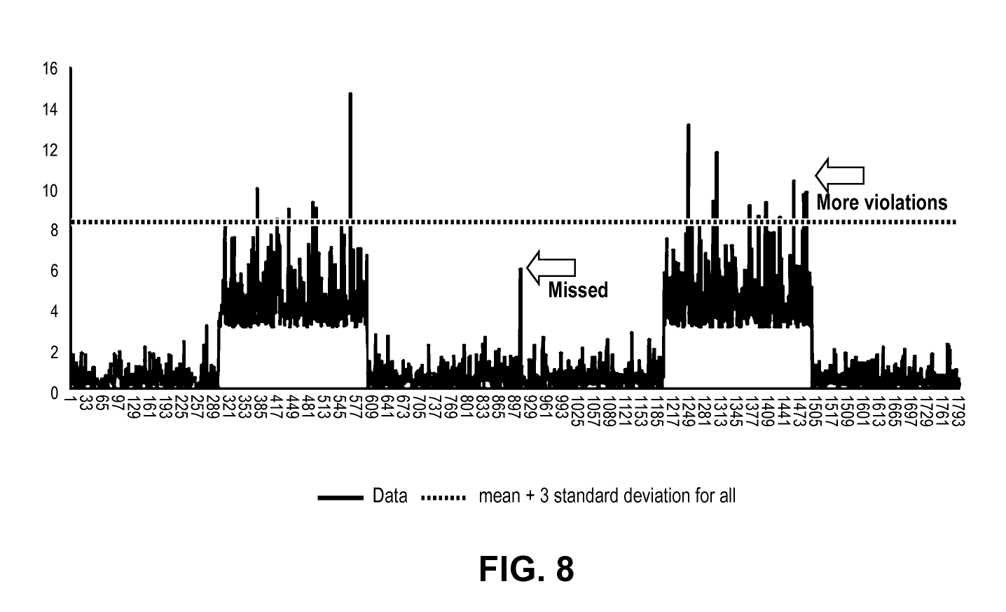

In contrast, the alarm engine 208 is configured to determine and generate alarm events based on thresholds from threshold engine 202, which are specific to an interval. For example, FIG. 9 shows how alarm engine 208 may use interval-oriented thresholds that are computed based on business hours. With the use of interval-oriented analysis, a higher threshold is computed by alarm engine 208 based only on the data from the business hour with larger average values and the lower threshold on the smaller values. The thresholds computed by alarm engine 208 according to business hours has fewer false alarms yet can capture more genuine anomalies.

Correlation Engine for Correlating Business and Performance Metrics According to Business Hour Patterns

In the embodiments, a correlation engine 214 is configured to determine statistical correlation for finding out the potential relationship between business and performance metrics. In the embodiments, the correlation engine 214 employs interval-oriented analysis, such as business hour patterns, as information that can reveal a deeper relationship between business and performance metrics.

For example, each business hour may exhibit distinct magnitudes of metric values. There is a distinction between seasonal high/low vs. high/low within a season. Seasonal highs and lows can be explained well by business reasons; highs and lows within a season are likely to be statistical variations.

FIG. 10 illustrates conventional correlation techniques that do not employ interval-oriented analysis. As shown, two metrics have a correlation coefficient (CC) 0.65. Since the range of a CC is between −1 and 1 (1 being the highest or strongest positive correlation value, 0 indicating no correlation at all, and −1 being the highest or strongest negative correlation value), A CC=0.65 indicates a moderately positive correlation between the two metrics. In other words, non-interval analysis leads to a result indicating that the two metrics are related.

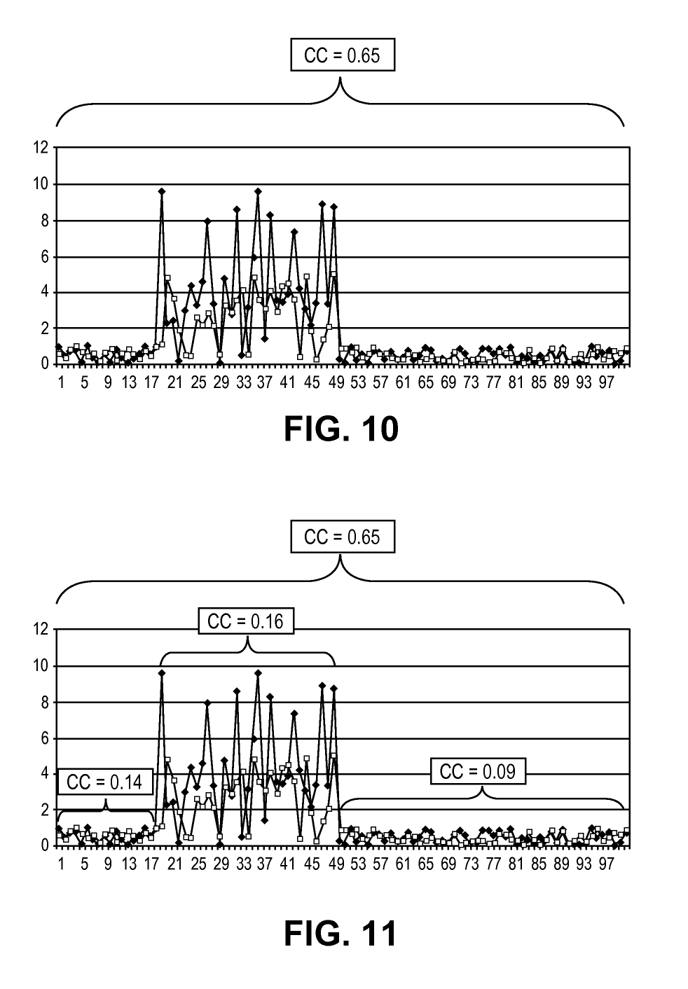

In contrast, the correlation engine 214 employs interval-oriented analysis. For example, the correlation engine 214 may partition the data into three sections and perform correlations for them separately. FIG. 11 shows the correlation coefficient for each section is much closer to 0, when using interval-oriented analysis. As shown in FIG. 11, based on an interval-oriented analysis, the two metrics are not conclusively correlated in general with CC=0.14, 0.16, and 0.09, respectively, for the three sections.

In this example, the middle section corresponds to a busy period during which the value for every metric is higher. For example, if an application supports business activities from 9 am to 5 pm, it is likely that the system is going to be busy during that interval and many measurements will have higher values. In the embodiments, correlating metrics with the data from the 9-5 interval is thus more meaningful and can help better determine how strongly metrics are related.

As explained below, the use of interval-oriented analysis by the correlation engine 212 improves the results of common statistical correlation formulas, such as the Pearson and Spearman formulas. For example, the Pearson formula has many different forms that provide insight on the factors that determine the value of the correlation coefficient.

In particular, given two metrics x and y, the Pearson correlation coefficient, CC_{P}(x,y), depends on the standard deviations σₓ and σ_{y} of metrics x and y, respectively, and their covariance σ_{xy}², σ_{xy}²=E(xy)−E(x)E(y):

$${CC}_{p} ( x , y ) = \frac{{σ}_{xy}^{2}}{{σ}_{x} {σ}_{y}} = \frac{E ( xy ) - E ( x ) E ( y )}{{σ}_{x} {σ}_{y}} \qquad ( 1 )$$

where E(x) is the mean (or expectation) of x.

The Pearson formula (1) implies that the value of the correlation coefficient depends on the means, standard deviations, as well as the mean of the product of the two metrics x and y Since the mean and standard deviation of each individual (distinct) interval is different from the mean and standard deviation of all sections combined, the CC for combined data will be different from the CC for each section. To analyze more closely, formula (1) can also be written as formula (2) below with n samples for each metric:

$$\begin{matrix}\begin{matrix}Pearson & Large CC means larger {\sum }_{i = 1}^{n} {x}_{i} {y}_{i}\end{matrix} & \\ {cc}_{p} = \frac{n {\sum }_{i = 1}^{n} {x}_{i} {y}_{i} - {\sum }_{i = 1}^{n} {x}_{i} {\sum }_{i = 1}^{n} {y}_{i}}{\sqrt{[ n {\sum }_{i = 1}^{n} {x}_{i}^{2} - {( {\sum }_{i = 1}^{n} {x}_{i} )}^{2} ] [ n {\sum }_{i = 1}^{n} {y}_{i}^{2} - {( {\sum }_{i = 1}^{n} {y}_{i} )}^{2} ]}} & ( 2 )\end{matrix}$$

From Pearson formula (2), it can be seen that the larger coefficient of variation, CC, implies larger Σᵢ₌₁ⁿxᵢyᵢ. With all other things equal i.e. Σᵢ₌₁ⁿxᵢ=X and Σᵢ₌₁ⁿyᵢ=Y, having larger xᵢ's multiplied with larger yᵢ's, or smaller xᵢ's multiplied with smaller yᵢ's will make the sum Σᵢ₌₁ⁿxᵢyᵢ larger. Taking two data pairs, (x₁, y₁) and (x₂, y₂) , as an example, assuming x₁+x₂=X and y₁+y₂=Y, if (x₁≧x₂) and (y₁≧y₂) then (x₁y₁+x₂y₂)−(x₁y₂+x₂y₁)=(x₁−x₂)(y₁−y₂)≧0, i.e., (Large×Large+Small×Small)≧(Large×Small+Large×Small).

A similar reasoning holds for Spearman's rank correlation. For example, in the Spearman's rank formula, a higher rank subtracting another higher rank and a lower rank subtracting another lower rank will make Σᵢ₌₁ⁿ[rank(xᵢ)−rank(yᵢ)]²smaller [formula (3)], therefore making the correlation coefficient CCₛlarger:

$$\begin{matrix}\begin{matrix}{Spearman}^{′} s rank & Large CC means smaller {\sum }_{i = 1}^{n} {[ rank ( {x}_{i} ) - rank ( {y}_{i} ) ]}^{2}\end{matrix} & \\ {cc}_{s} = 1 - \frac{6 {\sum }_{i = 1}^{n} {[ rank ( {x}_{i} ) - rank ( {y}_{i} ) ]}^{2}}{n ( {n}^{2} - 1 )} & ( 3 )\end{matrix}$$

Taking two data pairs, (x₁y₁) and (x₂y₂) as an example, where n=2,

if [rank(x₁)≧rank(x₂)] and [rank(y₁)≧rank(y₂)]

then

[rank(x₁)−rank(y₁)]²+[rank(x₂)−rank(y₂)]²−[rank(x₁)−rank(y₂)]²−[rank(x₂)−rank(y₁)]²

=−2[rank(x₁)−rank(x₂)][rank(y₁)−rank(y₂)]≦0.

That is

[rank(x₁)−rank(y₁)]²+[rank(x₂)−rank(y₂)]²≦[rank(x₁)−rank(y₂)]²+[rank(x²)−rank(y₁)]

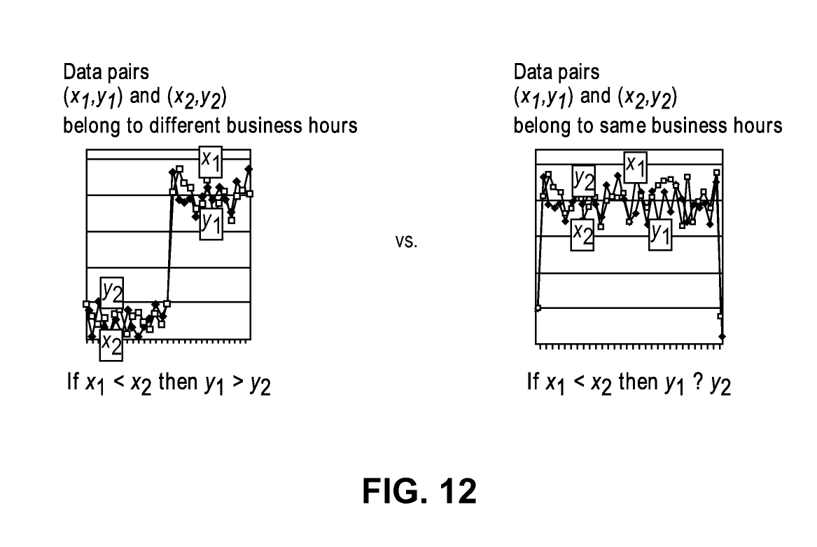

FIG. 12 illustrates the effect of defining distinct intervals and shows that if statistical correlation involves two or more very different business hours, it is more likely that if (x₁≧x₂) or [rank(x₁)≧rank(x₂)] then (y₁≧y₂) or [rank(y₁)≧rank(y₂)] as well, which will lead to a higher correlation coefficient for both Spearman's rank and Pearson correlation algorithms.

In particular, when data pairs belong to different business hours (left side of FIG. 12), it is more likely that if one value is greater than another value of the same metric (x₁>x₂) then the corresponding values of another metric will have the same relationship (y₁>y₂); when data pairs belong to the same business hour (right side of FIG. 12), if one value is greater than another value of the same metric (x₁>x₂) it is uncertain whether the corresponding values of another metric will have the same relationship (y₁>y₂) or an opposite one (y₁≦y₂). Therefore, the use of interval-oriented analysis in the embodiments can improve recognition of correlations between various metrics.

Improved, Modeling Engine that Uses Intervals for Performance Models According to Business Hour Patterns

In the embodiments, the monitoring server 116 may also comprise a modeling engine 214. As a part of the capacity planning process, the modeling engine 214 collects system and application data and establishes a baseline as a reference point to calibrate a performance model. The usefulness of the model created by the modeling engine 214 not only depends on an accurate abstraction of the system and workload behavior but also on the time domain from which data is collected and for which the model will be applied.

For example, a model calibrated with data from both busy (e.g., 9 am-5 pm) and idle (e.g., 12 am-8 am) intervals may not work well in predicting the performance of an application that is mainly running from 9 am-5 pm. Thus, in the embodiments, the modeling engine 214 is parameterized with aggregated data from a particular business hour and used for that hour based on information from interval definitions 212.

In the prior art, many capacity planning tools, whether they are queuing theory or discrete event simulation based, make statistical assumptions about the behavior of systems and applications prior to having even a single piece of performance data collected and analyzed. Often, the performance data is collected and processed to feed parameters required by the model, which frequently only characterize the average behavior of the systems and applications.

For example, in order to derive simple and useful formulas for transaction response time, the most common assumption that many tools make is that both transaction (job, workload, application, etc.) inter-arrival times and service times are exponentially distributed. That assumption implies that both inter-arrival times and service times are more or less random with their coefficient of variation (c), c₁² and c_{S}² respectively, equal to 1. Those assumptions work well in a relatively random system world with steady average and variation.

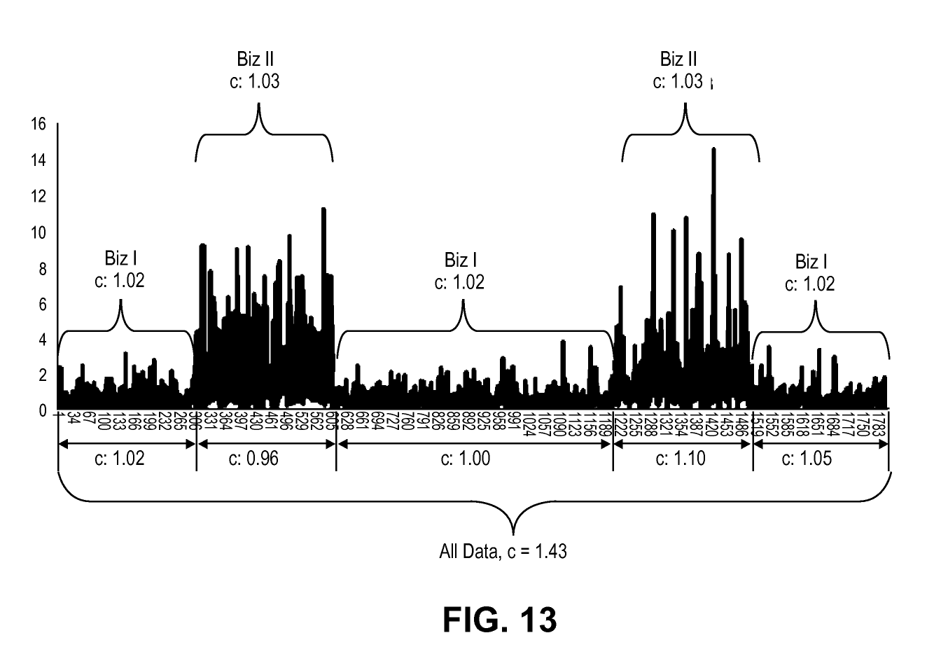

In the embodiments, the modeling engine 206 is capable of dealing with transaction inter-arrival times and/or service times change their intensities even though the underlying distributions are still exponentially distributed. For example, as shown in FIG. 13, the metric values for the five sections (three for Biz I and two for Biz II) are all exponentially distributed but the two sections for Biz II have much higher values (and averages). In fact, for the whole interval with all five sections, the distribution is no longer exponential because for the whole interval, the c=1.43. This example also shows that whether or not a particular business hour is selected has a direct impact on the validity of the performance model and its assumption.

If the inter-arrival times and/or service times are not exponentially distributed, as shown in FIG. 13, an approximate G/G/n queuing model is often used, where G represents a General or unknown distribution for transaction inter-arrival times or service times and n is the number of processors in a server.

In some embodiments, the modeling engine 208 may use the following average response time approximation for a G/G/n queue:

$$\overline{R} = s + \frac{{s}^{2} x}{n ( n - s x )} \frac{{c}_{l}^{2} + {c}_{s}^{2}}{2} , \qquad ( 4 )$$

where s is the service time for each processor or core in the server and x is the total throughput of the server. Note that when the inter-arrival times and service times are exponentially distributed, c₁=1 and cₛ=1 (4) becomes:

$$\overline{R} = s + \frac{{s}^{2} x}{n ( n - s x )} = s + {}^{``} M / M / n\_wait {\_time}^{″} . \qquad ( 5 )$$

The response time formula (5) is valid for all intervals of Biz I or Biz II, because the data for those intervals are exponentially distributed. However, if all the data from the whole interval is chosen, instead of using the data according to defined intervals, such as business hours, the response time equation (5) is no longer suitable.

Instead the approximate formula (4) is more appropriate. That is, if the inter-arrival time CC, c_{I}, is 1.43 and cₛ=1, then the waiting time in equation (4) becomes:

$$\overline{R} = s + \frac{{s}^{2} x}{n ( n - s x )} \frac{{1.43}^{2} + 1}{2} = s + 1.52 \times {}^{``} M / M / n\_wait {\_time}^{″} . \qquad ( 6 )$$

Accordingly, the waiting time when c_{I}=1.43 is more than 50% higher than the waiting time when c_{I}=1.

This example also illustrates that calibrating or parameterizing the performance model by modeling engine 206 with interval-oriented analysis, such as business hour information, not only makes business sense but also makes statistical sense. In particular, it makes performance models and assumptions more relevant to the real world data distribution. The prediction results by, modeling engine 206 will thus be much more accurate.

The features and attributes of the specific embodiments disclosed above may be combined in different ways to form additional embodiments, all of which fall within the scope of the present disclosure. Although the present disclosure provides certain embodiments and applications, other embodiments that are apparent to those of ordinary skill in the art, including embodiments, which do not provide all of the features and advantages set forth herein, are also within the scope of this disclosure. Accordingly, the scope of the present disclosure is intended to be defined only by reference to the appended claims.

What is claimed is:

1. A method for dynamically generating at least one metric threshold associated with a metric in a monitored system, the method comprising:
receiving data associated with a metric;
determining distinct intervals of time that result from external factors influencing activity of the monitored system;
statistically analyzing the received data for each distinct interval separately; and
determining at least one alarm threshold for future, similar intervals based on the statistical analysis.

2. The method of claim 1 wherein receiving the data comprises aggregating the received data based on an aggregation period for each distinct interval.

3. The method of claim 1, wherein determining the distinct intervals comprises receiving an input specifying the distinct intervals of time.

4. The method of claim 1, wherein determining the distinct intervals comprises receiving an input specifying hours of operations for the monitored system.

5. The method of claim 1, wherein determining the distinct intervals comprises receiving an input specifying a set of external factors that influence the activity of the monitored system.

6. The method of claim 1, wherein determining the distinct intervals comprises determining the distinct intervals of time from a heuristic analysis of the received data.

7. The method of claim 1, wherein statistically analyzing the received data:
receiving data at a first time scale; and
extrapolating received data at a second time scale for the distinct interval.

8. The method of claim 1, further comprising triggering an alarm on receipt of received data within a similar interval that violates the at least one alarm threshold.

9. The method of claim 1, further comprising:
statistically analyzing received data for at least one additional metric for one of the distinct intervals of time; and
correlating the metric and the at least one additional metric based on the statistical analysis within the distinct interval of time.

10. A method for monitoring a system, wherein activity of the system is influenced by external factors that result in intervals of different activity, the method comprising:
receiving data associated with a metric of the monitored system;
identifying time intervals of the received data based on information indicating the external factors;
determining, for each identified Urns interval, at least one value indicating a statistical distribution of values of the metric; and
determining, for subsequent intervals that are similar to the identified intervals of time, at least one threshold indicating a boundary of an abnormal value for the metric.

11. The method of claim 10, wherein identifying the time intervals comprises receiving information specifying a range of hours in a day.

12. The method of claim 10, wherein identifying the time intervals comprises receiving information specifying days of a week.

13. The method of claim 10, wherein identifying the time intervals comprises receiving information specifying days of a year.

14. The method of claim 10, wherein determining the at least one value indicating the statistical distribution comprises determining a mean value of the metric within each identified time interval.

15. The method of claim 10, wherein determining the at least one value indicating the statistical distribution comprises determining a standard deviation value of the metric within each identified time interval.

16. The method of claim 10, further comprising triggering an alarm event on receipt of received data within a subsequent interval that is similar to one of the identified intervals that violates the at least one threshold.

17. A system for monitoring a system, said system comprising:
a collector for receiving data for at least one metric of performance by the monitored system; and
a monitoring server configured to aggregate the received data, recognize time intervals of the received data corresponding to a distinct period of activity in the monitored system, determine, for each identified time interval, at least one value indicating a statistical distribution of values of the metric, and determining, for subsequent intervals that are similar to the identified intervals of time, at least one threshold indicating a boundary of an abnormal value for the metric.

18. The system of claim 17, wherein the monitoring server further comprises a data aggregator configured to aggregate the received data based on the identified intervals of time.

19. The system of claim 17, wherein the monitoring server is configured to determine the at least one threshold for each identified interval based on a mean value and standard deviation of the metric for each interval.

20. The system of claim 17, further comprising an alarm engine configured to generate an alarm event on receipt of received data within a subsequent interval that is similar to one the identified intervals that violates the at least one threshold.
